(19) United States
(12) Patent Application Publication
(10) Pub. No.: US 2021/0094570 A1
(43) Pub. Date: Apr. 1, 2021

(54) HUMAN-MACHINE INTERFACE APPARATUS FOR VEHICLE

(71) Applicant: SUZUKI MOTOR CORPORATION, Hamamatsu-shi (JP)

(72) Inventor: Hitoshi UCHIDA, Hamamatsu-shi (JP)

(21) Appl. No.: 17/030,283

(22) Filed: Sep. 23, 2020

(30) Foreign Application Priority Data
Sep. 26, 2019 (JP) 2019-175865

(51) Int. Cl. B60W 60/00; B62D 6/04; B60N 2/20; B60N 2/02; B60W 50/08

(52) U.S. Cl. CPC B60W 60/0013; B62D 6/04; B60W 50/08; B60N 2/0224; B60N 2/0296; B60N 2/20

(57) ABSTRACT

To provide a human-machine interface (HMI) apparatus that can convey a vehicle control intention of a system to a driver without causing an additional burden without relying on language or visual means. A human-machine interface (HMI) apparatus for a vehicle (1) including a vehicle control unit (10) capable of performing speed control and steering control on the basis of information obtained by an environmental condition estimating part (21-23) includes a seat (3) provided to be tiltable in a vehicle longitudinal direction, an actuator (30) configured to tilt the seat, and a seat tilting control unit (13) configured to make the actuator (30) perform control: to tilt the seat (3) forward when the vehicle control unit (10) performs deceleration control or when probability of performing deceleration control is recognized on the basis of the information obtained by the environmental condition estimating part (21-23); and to return the seat (3) to an original position when the deceleration control is performed or when the probability disappeared.

### FIELD OF THE INVENTION

The present invention relates to an HMI (Human-Machine Interface) apparatus for a vehicle, and more particularly, relates to an HMI apparatus for a vehicle equipped with an advanced driving support system or an automated driving system.

### BACKGROUND OF THE INVENTION

In vehicles equipped with advanced driving support functions or automated driving functions in which systems perform some or all of recognition, determination, and operation conventionally performed by drivers, when control such as steering or acceleration/deceleration is performed, drivers and occupants may not be able to quickly understand the purpose or intent of the control and may feel uncomfortable or uneasy.

JP 2015-199439 discloses determining driving behavior contents that should be taken by a vehicle on the basis of external recognition information including obstacles and other vehicles on a driving path and information about the vehicle, and presenting a driver with information on vehicle control performed as a result of the determination and a causal event of the control.

However, since linguistic means, such as explanatory texts, or abstract visual displays, such as icons, is used, the driver needs to recognize and understand expressions of an HMI (Human-Machine Interface), and there is a problem in that a new burden of instrument monitoring is caused, even though the technology is aimed at reducing the burden on the driver.

In commercially available vehicles, there is also a visual HMI that displays information such as form of the road ahead and surrounding vehicles, recognized by sensors. However, such an HMI display may force the driver to work with a high cognitive load, such as some kind of “mistake finding” by comparing “external and road conditions seen by the driver's own eyes” with “external and road conditions recognized by the system” displayed on the HMI.

Vehicle control intentions of an automated driving system or an advanced driving support system sometimes are not conveyed to drivers, and the drivers may feel pointless anxiety. For example, when a curve ahead is approaching, if a vehicle speed is “a speed at which the vehicle can safely pass through the curve,” the system maintains a constant speed. However, since the driver does not know whether the vehicle is correctly recognizing the curve ahead and controlling the vehicle, the driver is likely to feel anxious. The existing HMI display cannot respond to such a problem.

### SUMMARY OF THE INVENTION

The present invention has been made in view of the above-described actual circumstances, and an object is to provide a human-machine interface (HMI) apparatus that can convey a vehicle control intention of a system to a driver in a vehicle equipped with an advanced driving support system or an automated driving system without causing a new burden and without relying on language or visual means.

In order to solve the above-described problems, the present invention is

A human-machine interface (HMI) apparatus for a vehicle including:

an environmental condition estimating part including a surrounding recognition function for recognizing a driving path ahead of the vehicle and other vehicles and a function for obtaining the vehicle's moving state; and

a vehicle control unit capable of performing: speed control to maintain a target inter-vehicle distance from a preceding other vehicle or a target vehicle speed on the basis of information obtained by the environmental condition estimating part; and steering control to make the vehicle follow a target path generated on the basis of the information obtained by the environmental condition estimating part,

the HMI apparatus comprising:

a seat provided to be tiltable in a vehicle longitudinal direction;

an actuator configured to tilt the seat; and

a seat tilting control unit configured to make the actuator perform control: to tilt the seat forward when the vehicle control unit performs deceleration control or when probability of performing deceleration control is recognized on the basis of the information obtained by the environmental condition estimating part; and to return the seat to an original position when the deceleration control is performed or when the probability disappeared.

According to the HMI apparatus for a vehicle according to the present invention, when the vehicle control unit performs deceleration control or when probability of performing deceleration control is recognized, that is, when it is predicted to shift to deceleration control even if the vehicle is accelerating or driving at a constant speed, the seat is slightly tilted forward so as to generate a change in jerk (differentiation of acceleration), which is more perceptible to humans than acceleration, and make the driver feel a pseudo-deceleration start, and thereby convey a system intention of performing driving control suitable for the situation to the driver, and as a result, the driver's sense of security can be improved, and in addition to that, the system intention is directly conveyed through somatic (haptic) sensation without relying on language or visual means, and without causing a new burden on the driver.

### BRIEF DESCRIPTION OF DRAWINGS

FIG. 1 is a schematic side view showing a basic configuration of an HMI apparatus.

FIG. 2A is a schematic side view showing an operation principle of the HMI apparatus.

FIG. 2B is a schematic graph showing a relationship between the seat forward tilting angle, acceleration, and jerk.

FIG. 3 is a block diagram showing a system configuration of the HMI apparatus.

FIG. 4 is a block diagram showing control processing of the HMI apparatus.

FIG. 5 is a schematic graph showing a relationship between acceleration and jerk at the time of deceleration.

FIG. 6 is a schematic graph showing pseudo-deceleration during driving at constant speed.

FIG. 7 is a schematic graph showing pseudo-jerk emphasizing a deceleration start.

FIG. 8 is a graph showing a simulation at the time of performing smooth deceleration.

FIG. 9 is a flowchart showing a deceleration control execution probability determination.

FIG. 10 is a schematic graph showing control of pseudo-deceleration corresponding to actual deceleration.

### DETAILED DESCRIPTION OF THE DRAWINGS

Hereinafter, embodiments of the present invention will be described in detail with reference to the drawings.

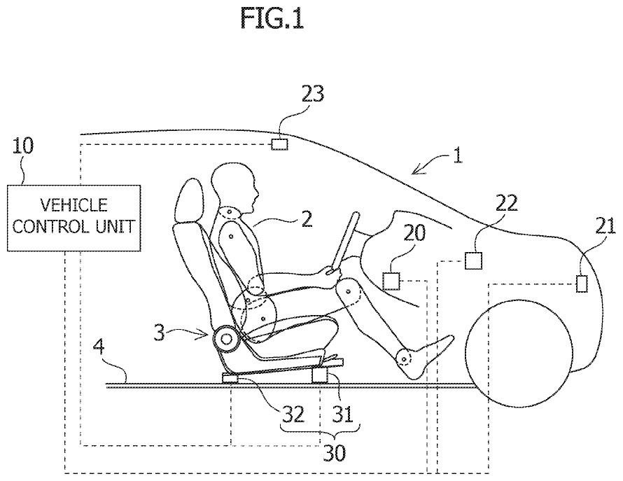

In FIG. 1, a vehicle 1 equipped with an HMI apparatus according to the present invention includes forward detection means, such as a front sensor 21 and a front camera 23, for detecting the surrounding environment such as a driving path ahead and other vehicles, and a vehicle control unit 10 (automated driving controller) for performing speed control and steering control on the basis of detection information thereof, and the HMI apparatus includes an actuator 30 for tilting a seat 3 in order to directly convey control information from the vehicle control unit 10 to a driver 2 as bodily sensation.

Although not particularly limited, the seat 3 is connected to a vehicle body floor 4 at a base frame of a seat assembly including a reclining mechanism and a front-back sliding mechanism and is connected to a vehicle body floor 4 so that it can tilt around a vehicle width direction axis. In the example shown, the actuator 30 is composed of two front and rear actuators 31 and 32, but can be composed of one actuator.

Although shown schematically in FIG. 1, each of the actuators includes a fixed end and an operating end that linearly moves or rotates with respect to the fixed end, and for example, the fixed end is connected to the vehicle body floor 4 and the operating end is connected to the seat 3 (base frame). As the actuator 30 (31 and 32), any form of actuator such as a motor, one of an electromagnetic type, or one of a hydraulic type, can be used. Furthermore, drive of the actuator can be transmitted through a mechanism such as a linkage, lever, screw feed, cam, worm gear, or rack-and-pinion.

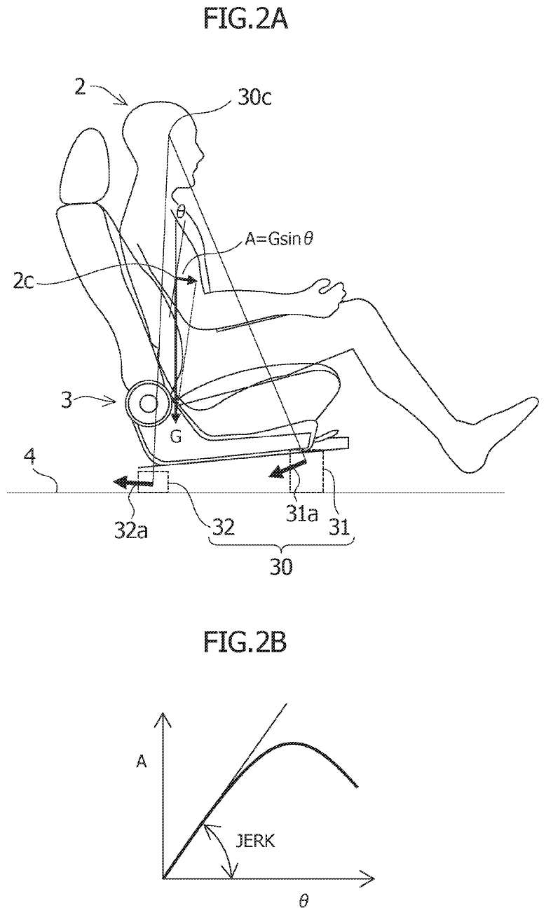

FIG. 2A shows an operation principle according to a preferred embodiment of the actuator 30 (31 and 32) and the seat 3. In the embodiment, the seat 3 is connected to the vehicle body floor 4 at two front and rear places, movably in directions indicated by arrows 31a and 32a, respectively.

For example, connection portions (31 and 32) at the two front and rear places are composed of arc grooves centered on a point 30c (vehicle width direction axis) formed on a support (bracket) on the vehicle body floor 4 side and rollers (pins) provided on the base frame of the seat 3 and movably engaging along the respective arc grooves, and by moving the front portion of the seat 3 rearward and downward (31a) along the arc groove and the rear portion rearward and slightly upward (32a) along the arc groove by the actuator 30, the seat 3 rotates on the point 30c (vehicle width direction axis) near the head of the driver 2, and tilts forward.

When the seat 3 is tilted forward by an angle (θ), an acceleration A corresponding to a component force (G sin θ) of the gravitational acceleration G is generated. For example, assuming that a rotational radius from the center point 30c to each support point (31a or 32a) in the forward tilting of the seat 3 is 600 mm, the seat 3 can be tilted by one degree by a stroke of 10 mm of the actuator 30 (31 and 32) at each support point.

When the vehicle decelerates, a negative acceleration (deceleration) in a direction opposite to the driving direction is generated in the vehicle body, and therefore, the driver 2 who has been moving at the same speed as the vehicle body generates a forward acceleration with respect to the vehicle body (seat 3). Consequently, the forward acceleration (G sin θ) by forward tilting of the seat 3, as described above, gives the driver 2 a feeling as if deceleration of the vehicle has started. The acceleration generated by the forward tilting of the seat 3 like this is different from the acceleration of the vehicle body, but simulates deceleration of the vehicle body, so hereinafter, it is referred to as “pseudo-acceleration”, and jerk caused by this is referred to as a “pseudo-jerk”.

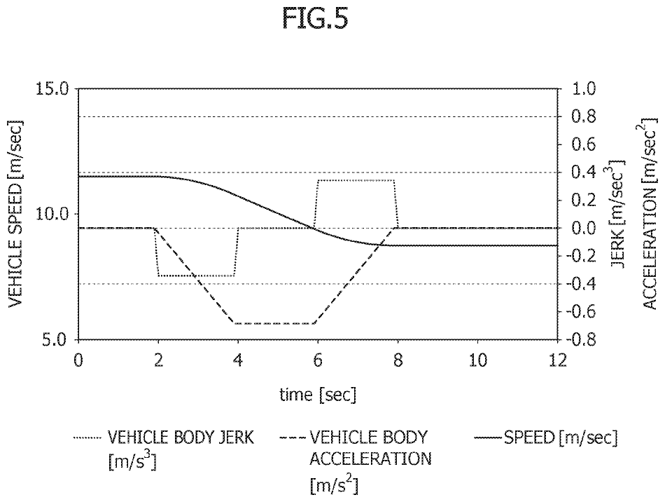

As a reference example, FIG. 5 is a graph schematically showing changes in speed, acceleration and jerk when the vehicle decelerates. It is assumed in the graph that, after driving at a constant speed of 11.5 m/sec up to the 2 second point, acceleration in the opposite direction to the speed (deceleration) increases in the 2 to 4 second interval and then starts deceleration, and after decelerating at a constant deceleration in the 4 to 6 second interval, the deceleration is decreased in the 6 to 8 second interval, and after 8 second point, driving at a constant speed of 8.7 m/sec is performed. In the graph, jerk immediately reaches the maximum value in the deceleration direction at the time point of deceleration start.

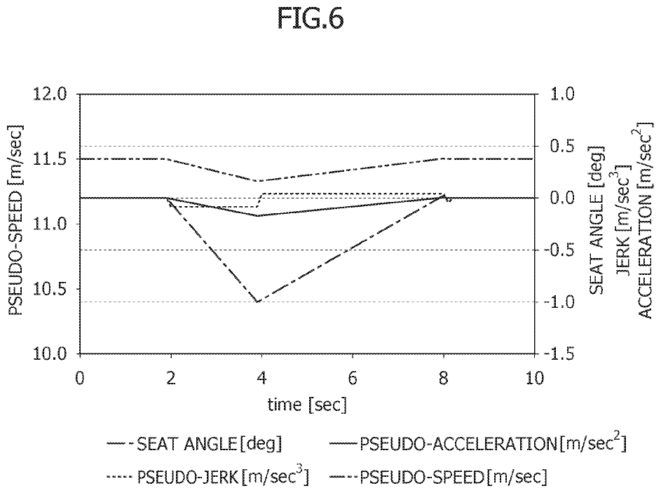

FIG. 6 is a graph schematically showing changes in pseudo-speed (deceleration), pseudo-acceleration and pseudo-jerk generated by the forward tilting operation of the seat 3 in the HMI apparatus. It is assumed in the graph that the seat 3 is fixed up to the 2 second point, and is tilted forward until 1 degree for 2 seconds of the 2 to 4 second interval, and then returns to the original position taking 4 seconds in the 4 to 8 second interval. With such tilting of the seat 3, the driver is given a pseudo-feeling that the vehicle decelerated in the 2 to 4 second interval and then gently accelerated. Although changes in pseudo-speed and pseudo-acceleration are small, since pseudo-jerk acts when the seat 3 starts tilting forward, bodily sensation like when the accelerator is temporarily eased off, is given.

In the HMI apparatus shown in FIG. 2A, a forward tilting angle θ that does not affect driving operation and does not cause a feeling of uncomfortable sitting is up to about 2 degrees, and the acceleration A generated by the forward tilting operation within this range is slight. However, the jerk, as a time differentiation of the acceleration A, has a large effect on human subjectivity (kinesthetic sensation and balancing sensation), and is effective as an HMI that conveys information to humans because the jerk per seat forward tilting angle is the maximum at the forward tilting start time point from an initial position of the seat 3 as shown in FIG. 2B.

In particular, in the HMI apparatus shown in FIG. 2A, since the center 30c of the forward tilting operation of the seat 3 is close to the head of the driver 2, when the seat 3 tilts forward, the head (eyeballs) of the driver 2 has no translational motion, and the movement is the minimal motion mainly consisting of a rotational motion, but is perceived as angular acceleration by a vestibular oculomotor reflex (VOR) accompanying this rotational motion and an inner ear semicircular canal, and is further effective.

As the tilting mechanism of the seat 3, other than the aforementioned sliding mechanism by arc grooves or arc rails, a four-bar linkage (quadrilateral linkage) in which an instantaneous center (30c) of tilting is located in a range above a seat surface of the seat 3 and in front of a seatback or a headrest, or a slide link mechanism in which one of the arc grooves is replaced with a link, can be used.

As a further other tilting mechanism, an actuator can be provided that rotatably supports any one of the front and rear connection portions (31 and 32) of the seat 3 on a support on the vehicle body floor 4 side with a pin joint or the like, and moves up and down the other connection portion (31 or 32). In this case, although the translational motion of the head of the driver 2 is involved, since the stroke itself associated with the seat forward tilting is small, as described above, the translational component is also relatively small.

Next, an outline and driving control of a vehicle equipped with the HMI apparatus configured as above will be described with reference to the drawings.

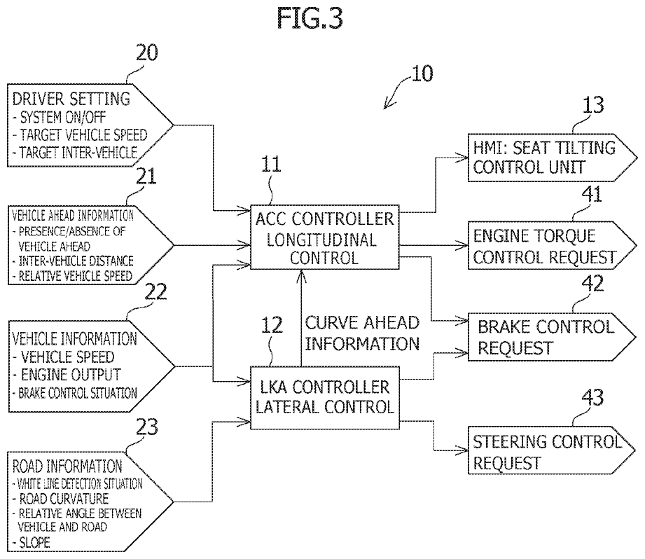

In FIG. 3, the vehicle control unit 10 includes an ACC controller 11 that performs longitudinal control (speed control and inter-vehicle distance control) of the vehicle 1 and an LKA controller 12 that performs lateral control (steering control and lane maintaining control), and performs driving control of the vehicle 1 on the basis of acquisition information of the environmental condition estimating part including a surrounding recognition function of the front sensor 21, vehicle information 22 on the vehicle's moving state, and road information by the front camera 23 or the like.

The front sensor 21 is a sensor for detecting presence of vehicles ahead and obstacles on the driving path ahead of the vehicle and vehicle ahead information such as relative distance (inter-vehicle distance and inter-vehicle time) and relative speed, and is composed of a millimeter waver radar, a LIDAR, or the like, but when a stereo camera is used for the front camera 23, information on vehicles ahead and obstacles can be also acquired from an image thereof. As the front camera 23, a monocular camera or a stereo camera can be used, and lane markings and the like on the road that define the vehicle's lane and neighboring lanes are detected by image processing.

The vehicle information 22 is physical quantities representing the vehicle 1 moving state measured by a vehicle speed sensor, a yaw rate sensor, an acceleration sensor and the like, an engine output, a brake control situation, and the like, and is transmitted to the vehicle control unit 10 through an on-vehicle network.

When the road (driving lane) is recognized from lane markings, road structures, or the like detected by the front camera 23, and a target path for steering control is generated, road information such as a road curvature ahead of the vehicle, a relative angle between the vehicle and the road, and grade is acquired. As the road information, a road curvature and a road gradient given as map information can also be referred to by a navigation function for guiding a path on the basis of own vehicle position information by positioning means, such as GPS, and map information.

The LKA controller 12 refers to the vehicle information 22 and gives a steering control request 43 (steering angle command) for making the vehicle 1 follow the target path generated on the basis of the road information to an EPS (electric power steering) controller. At this time, if lateral acceleration at the time of turning the curve estimated from the vehicle 1 moving state and the road curvature ahead of the vehicle is equal to or greater than a predetermined value, information of the curve ahead is transmitted to the ACC controller 11 and reflected in acceleration/deceleration control. In addition, road gradient information related to acceleration/deceleration is also transmitted to the ACC controller 11 and reflected in acceleration/deceleration control.

The ACC controller 11 performs speed control to maintain the target vehicle speed by driver setting of a setting part 20 to perform constant speed driving when there is no vehicle ahead in a detection range of the front sensor 21, and to follow a vehicle ahead while maintaining an inter-vehicle distance corresponding to a target inter-vehicle (inter-vehicle time=inter-vehicle distance/the vehicle's speed) by the driver setting of the setting part 20 when the vehicle catches up a vehicle ahead (when a vehicle ahead speed is equal to or less than the target vehicle speed).

That is, a brake controller that has received a brake control request 42 (deceleration command) from the ACC controller 11 issues a hydraulic command to a brake actuator, and controls vehicle speed by controlling braking force of a brake. An engine controller that has received an engine torque control request 41 (acceleration/deceleration command) from the ACC controller 11 gives a torque command to an engine 42 by controlling an actuator output (throttle opening), and controls vehicle speed by controlling driving force.

The vehicle control unit 10 (ACC controller 11 and LKA controller 12) includes one or more computers for performing the processing as above, that is, a ROM for storing programs and data, a CPU for performing arithmetic processing, a RAM for reading out the programs and the data and storing dynamic data and arithmetic processing results, an input/output interface and the like, and constitutes an advanced driving support system or an automated driving system including the ACC function and the LKA function, together with the environmental condition estimating part including the front sensor 21, the vehicle information 22 and the front camera 23, the engine controller (41), the brake controller (42), a steering controller (43) and the like.

Next, operation of the HMI apparatus in the driving control of the vehicle will be described.

In the vehicle 1 equipped with the driving control system as above, when detecting an event that causes the vehicle 1 to decelerate, such as a curve ahead or road gradient, or approach of a vehicle ahead, the HMI apparatus performs HMI seat forward tilting control 13 to tilt the seat 3 forward so as to generate a change in jerk (differentiation of acceleration) in the driver, to make the driver experience a pseudo-deceleration start, and thereby conveys a system intention that the vehicle 1 is performing driving control suitable for the road conditions and surrounding environment to the driver.

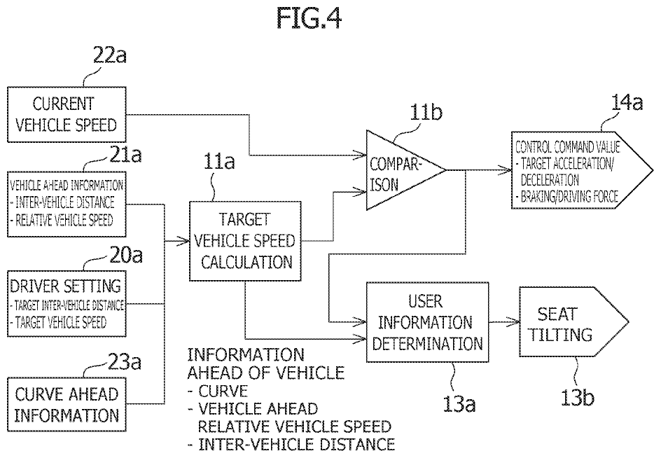

FIG. 4 shows speed control by the vehicle control unit 10 (ACC controller 11) and control of the HMI apparatus accompanying the speed control. Note that numeral parts of reference signs in FIG. 4 correspond to blocks of the same reference signs in FIG. 3.

The ACC controller 11 calculates a target vehicle speed 11a on the basis of vehicle ahead information 21a (inter-vehicle distance and relative speed), driver setting 20a (target inter-vehicle distance and target speed) and curve ahead information 23a (curve curvature), compares 11b the calculated target speed with a current vehicle speed 22a, and based on that, calculates a control command value 14a (target acceleration/deceleration and braking/driving force) to the engine controller and the brake controller.

In parallel with this, the curve ahead information 23a (curve curvature) and the vehicle ahead information 21a (inter-vehicle distance and relative speed) at the time of the target vehicle speed calculation 11a, and the control command value 14a (target acceleration/deceleration) are referred to in a user information determination 13a (deceleration control execution and probability determination) in HMI seat tilting control 13, and seat tilting 13b is executed based on it.

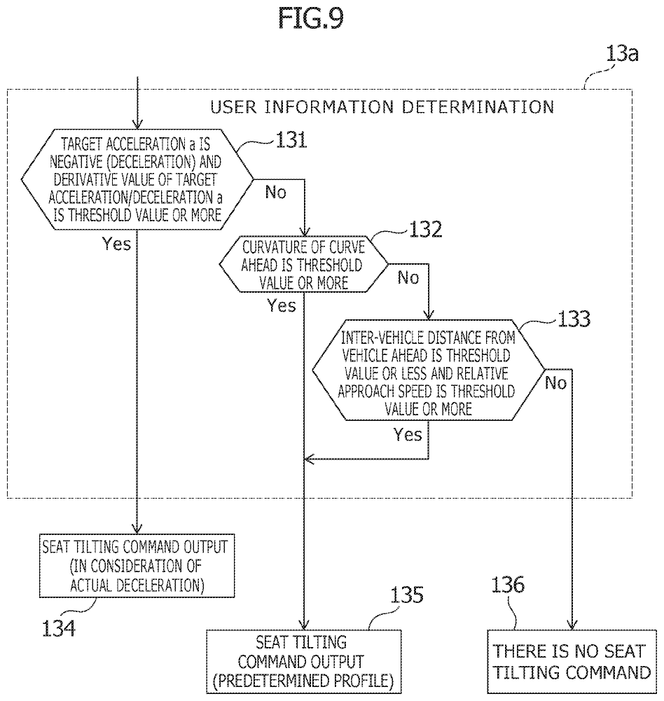

FIG. 9 shows one example of the user information determination 13a.

As shown, first, it is determined whether a target acceleration/deceleration a is negative (deceleration) and a derivative value of the target acceleration/deceleration a is equal to or greater than a predetermined threshold value (step 131).

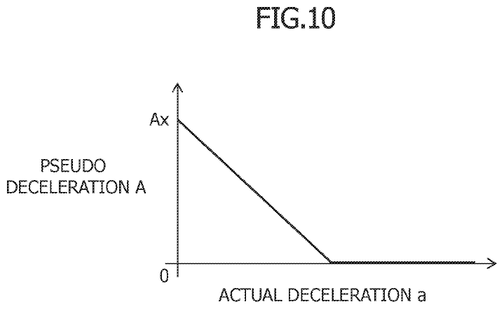

A case in which this determination is satisfied is a case in which deceleration control is executed (or there is probability that deceleration control will be executed, which will be described later), and is a situation in which deceleration of the vehicle is predicted, and a seat tilting command is output (step 134). As shown in FIG. 10, the seat tilting command in this case decreases a seat inclination in inverse proportion to an actual deceleration a of the vehicle body so that the actual deceleration a generated in the vehicle body becomes zero when the actual deceleration a exceeds a pseudo-deceleration A corresponding to a previously arranged seat tilting angle.

If the determination in step 131 is not satisfied, it is determined whether the curvature of a curve ahead is equal to or greater than a predetermined threshold value (step 132).

If the determination is satisfied, the curvature of the curve ahead is a curvature the driver recognizes as a sharp curve, and there is probability that deceleration control will be executed, so a seat tilting command is issued (step 135). In this case, a command of the previously arranged seat tilting angle is output.

If the determination in step 132 is not satisfied, it is determined whether an inter-vehicle distance (inter-vehicle time) from a vehicle ahead is equal to or less than a predetermined threshold value and a relative approach speed to the vehicle ahead is equal to or greater than a predetermined threshold value (step 133).

If the determination is satisfied, it is in a situation in which the driver is aware that the vehicle ahead is approaching, and there is probability that deceleration control will be performed, so a seat tilting command is output (step 135).

If the determination in step 133 is not satisfied, it is considered that there is no probability that deceleration control will be performed, so no seat tilting command is output (step 136).

Since the user information determination 13a as above is executed by referring to parameters of speed control (deceleration control) and steering control of the vehicle as shown in FIG. 4 and reflecting the parameters, the threshold values in the user information determination 13a do not affect driving control of the vehicle and can be set to values different from threshold values of driving control.

The vehicle control unit 10 constantly monitors physical values relating to the vehicle ahead information detected by the front sensor 21, the road information detected by the front camera 23, and the vehicle information 22 such as vehicle speed, engine output, and brake control situation, and if any of the physical values exceeds a corresponding threshold value of driving control, starts deceleration control of the vehicle, and it can be said that there is probability that deceleration control will be started when any of the physical values exceeds a normal base line, although it is less than the threshold value of driving control, or when it is exceeding the normal base line and approaching the threshold value of driving control.

Therefore, in execution of seat tilting 13b in an HMI seat tilting control unit 13, basically there are two modes as follows. That is,

(i) when a monitoring object physical quantity is less than a deceleration control threshold value, but is equal to or greater than a seat tilting control threshold value,

only seat tilting control is performed to make the driver experience pseudo-deceleration, and

to convey a system intention that the vehicle is preparing for deceleration control to the driver.

(ii) when the monitoring object physical quantity is equal to or greater than the deceleration control threshold value,

seat tilting control is performed at the same time as deceleration control of the vehicle

to make the driver clearly experience the deceleration control start of the vehicle by pseudo-deceleration, and

to convey the system intention that the vehicle is performing deceleration control to the driver.

In the above (i), for example, even at a speed that does not require deceleration control when entering a curve, only the seat tilting control is executed as shown in FIG. 6, and the driver can experience pseudo-deceleration (pseudo-jerk) like easing off the accelerator just before the curve, and can be easily understood that the system is correctly recognizing and responding to the curve ahead.

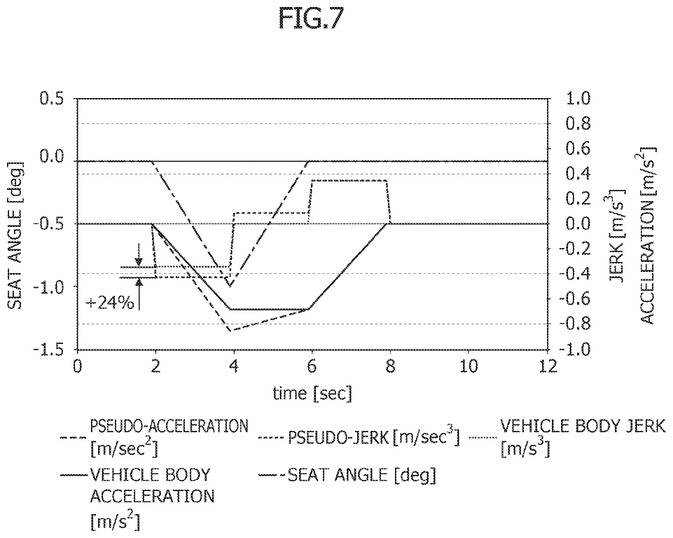

In the above (ii), for example, when deceleration control is required when entering a curve, seat tilting control is performed at the same time as a start of deceleration control as shown in FIG. 7, gentle deceleration control is emphasized by pseudo-deceleration (pseudo-jerk), and the driver can easily understand that the system has entered deceleration control right before the curve.

In the example shown in FIG. 7, seat tilting control is performed at the same time as the start of deceleration control of the vehicle, the pseudo-jerk is added to vehicle body jerk, and jerk experienced by the driver is increased by 24%. Then, when deceleration of the vehicle becomes constant (four-second point), return to the original position of the seat 3 is started and the return to the original position is completed before decrease of the deceleration starts.

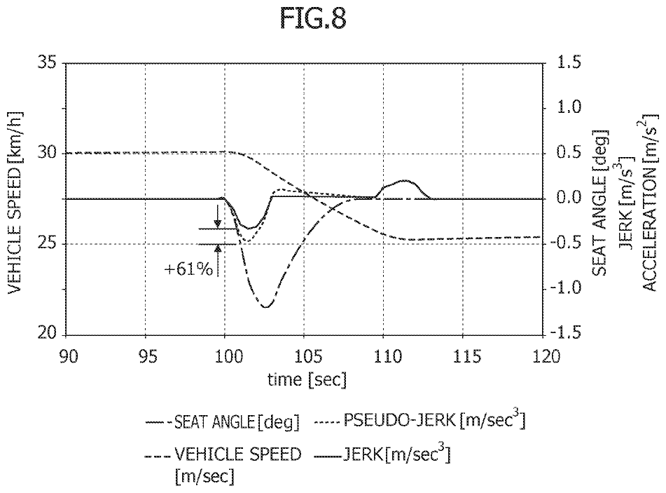

FIG. 8 shows a simulation when gentle deceleration control is executed. Seat tilting control is performed at the same time as the start of deceleration control during driving at a constant speed of 30 km/h, and after reaching the maximum forward tilting angle −1.2 degrees at the maximum deceleration −0.06 G around 102.5 seconds, the seat 3 is returned to the original position and the vehicle is decelerated to 25 km/h taking about 10 seconds.

As is clear also from FIG. 8, a seat original position return speed is lower than a seat forward tilting speed, and a seat original position return time is longer than a seat forward tilting time. In a preferred embodiment, the seat forward tilting time is 0.2 to 2 seconds, the maximum forward tilting angle is 2 degrees, and the seat original position return time is 1.5 to 3 times the seat forward tilting time.

In the above example, as a case in which there is a probability of deceleration control, the case in which the curvature of the curve ahead is equal to or greater than the threshold value, the case in which a vehicle ahead approaches, and the like are described, but other than these, in various cases in which deceleration control is predicted, for example, when a road ahead gradient is a downward slope, when there is lane decrease or road width decrease ahead, and when another vehicle entering ahead of the vehicle from a side junction flow path is detected, the above-described bodily sensation HMI apparatus can be implemented.

### OPERATION AND EFFECTS

As detailed above, the HMI apparatus for the vehicle according to the present invention obtains information from the front sensor, such as a camera and a radar, used for speed control of the vehicle by the driving control system, monitors a change leading to deceleration control when a certain reference is satisfied, tilts the seat forward by the actuator when detecting an event that does not lead to a deceleration control start but has a probability of shifting to deceleration control, or when starting deceleration control, and makes the driver experience a jerk change corresponding to an increase in deceleration.

Thereby, the bodily sensation HMI apparatus can be implemented in which the driving control system detects a forward event such as road conditions or vehicles ahead, makes the driver experience preparation for control by pseudo-deceleration, and effectively conveys it.

Although deceleration in response to the forward event is a highly universal sense and coping behavior, since actual vehicle behavior does not change, both reasonable vehicle speed control and monitoring of vehicle operation status by the driver can be achieved, information can be conveyed to only the driver (seat user) through bodily sensation, that is, somatic sensation (kinetic sensation) and vestibular sensation (balancing sensation) without affecting other occupants, and information can be accurately conveyed even when the driver is not paying attention to vehicle instruments. In addition, preliminary notification of a change in vehicle behavior is possible before actual acceleration/deceleration starts.

Although some embodiments of the present invention have been described above, the present invention is not limited to the above-described embodiments, and further various modifications and changes are possible within the scope of the present invention.

1. A human-machine interface (HMI) apparatus for a vehicle comprising:
an environmental condition estimating part including a surrounding recognition function for recognizing a driving path ahead of the vehicle and other vehicles and a function for obtaining the vehicle's moving state; and
a vehicle control unit capable of performing: speed control to maintain a target inter-vehicle distance from a preceding other vehicle or a target vehicle speed on the basis of information obtained by the environmental condition estimating part; and steering control to make the vehicle follow a target path generated on the basis of the information obtained by the environmental condition estimating part,
the HMI apparatus comprising:
a seat provided to be tiltable in a vehicle longitudinal direction;
an actuator configured to tilt the seat; and
a seat tilting control unit configured to make the actuator perform control: to tilt the seat forward when the vehicle control unit performs deceleration control or when probability of performing deceleration control is recognized on the basis of the information obtained by the environmental condition estimating part; and to return the seat to an original position when the deceleration control is performed or when the probability disappeared.

2. The HMI apparatus for a vehicle, according to claim 1, wherein tilting backward for returning the seat to the original position is executed at a speed lower than a speed for tilting the seat forward.

3. The HMI apparatus for a vehicle, according to claim 1, wherein an instantaneous center of the tilting is located above a seat surface of the seat and in front of a seatback or a headrest.

4. The HMI apparatus for a vehicle, according to claim 1, wherein a tilting angle of the seat is less than 2 degrees.

5. The HMI apparatus for a vehicle, according to claim 1, wherein when the probability of performing the deceleration control is recognized includes when a vehicle ahead enters within a predetermined inter-vehicle distance greater than the target inter-vehicle distance and a relative approach speed of the vehicle ahead is determined to be equal to or greater than a threshold value, or when a curvature of a curve ahead is determined to be equal to or greater than a threshold value.

6. The HMI apparatus for the vehicle, according to claim 5, wherein the environmental condition estimating part further includes a navigation function for guiding a path on the basis of the vehicle itself position information by positioning means and map information, and a determination of the curvature of the curve ahead is made referring to a road curvature given as map information.

7. A human-machine interface (HMI) apparatus for a vehicle comprising:
an environmental condition estimating part including a surrounding recognition function for recognizing a driving path ahead of the vehicle and other vehicles and a function for obtaining the vehicle's moving state; and
a vehicle control unit capable of performing speed control to maintain a target inter-vehicle distance from a preceding other vehicle or a target vehicle speed on the basis of information obtained by the environmental condition estimating part,
the HMI apparatus comprising:
a seat provided to be tiltable in a vehicle longitudinal direction;
an actuator configured to tilt the seat; and
a seat tilting control unit configured to make the actuator perform control: to tilt the seat forward when the vehicle control unit performs deceleration control or when probability of performing deceleration control is recognized on the basis of information obtained by the environmental condition estimating part; and to return the seat to an original position when the deceleration control is performed or when the probability disappeared.
